(19) United States
(12) Patent Application Publication
(10) Pub. No.: US 2012/0290364 A1
(43) Pub. Date: Nov. 15, 2012

(54) SCORING SUPPLIER PERFORMANCE

(75) Inventors: Sai Zeng, Yorktown Heights, NY (US); Jakka Sairamesh, Menlo Park, CA (US); Mitchell A. Cohen, Yorktown Heights, NY (US); Benjamin J. Steele, Newburgh, NY (US)

(73) Assignee: International Business Machines Corporation, Armonk, NY (US)

(21) Appl. No.: 13/552,007

(22) Filed: Jul. 18, 2012

Related U.S. Application Data
(62) Division of application No. 12/245,457, filed on Oct. 3, 2008.

(51) Int. Cl. G06Q 10/06

(52) U.S. Cl. 705/7.38

(57) ABSTRACT

A method includes receiving a supplier scoring tree having a first node including a first function of supplier performance connected via a first link to a second node operative to receive a first value associated with a metric of the supplier performance, receiving the first value, performing the first function of the first node, outputting a result of the function to a display, and displaying the result value to a user for analysis of supplier performance by the user.

### CROSS-REFERENCE TO RELATED APPLICATIONS

This is a divisional application of application Ser. No. 12/245,457, filed Oct. 3, 2008, which is incorporated by reference herein.

### BACKGROUND

Diverse groups within large companies interact with suppliers that provide materials and services to the groups. Each group has different interests and priorities regarding supplier performance. For example, one group may be more interested in the ability of a supplier to meet delivery deadlines, while another group may be more interested in the quality control of a supplier.

Previous methods of evaluating supplier performance used worksheets with objective criteria to evaluate a supplier. The worksheets used linear functions to calculate an overall supplier performance score. Subjective criteria and non-linear functions were typically avoided.

A flexible, efficient, and effective method of scoring supplier performance is desired.

### BRIEF SUMMARY

The shortcomings of the prior art are overcome and additional advantages are achieved through an exemplary method comprising, defining a supplier scoring tree by, receiving a function of a supplier performance, defining a first node to include the function of the supplier performance, receiving a first value associated with a metric of the supplier performance, defining a second node to receive the first value associated with a metric of the supplier performance, and connecting the first node to the second node with a link, outputting the defined supplier scoring tree to a display, and displaying the defined supplier scoring tree to a user for analysis of supplier performance by the user.

An alternate method comprising, receiving a supplier scoring tree having a first node including a first function of supplier performance connected via a first link to a second node operative to receive a first value associated with a metric of the supplier performance, receiving the first value, performing the first function of the first node, outputting a result of the function to a display, and displaying the result value to a user for analysis of supplier performance by the user.

A system comprising, a processor operative to receive a function of a supplier performance, define a first node to include the function of the supplier performance, receive a first value associated with a metric of the supplier performance, define a second node to receive the first value associated with a metric of the supplier performance, and connect the first node to the second node with a link, output the defined supplier scoring tree, and a display operative to receive and display the defined supplier scoring tree to a user for analysis of supplier performance by the user.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 illustrates an exemplary embodiment of a scoring tree.

FIG. 2 illustrates an exemplary embodiment of a supplier scoring system.

FIG. 3 illustrates a block diagram of an exemplary method of computing a score from the scoring tree of FIG. 1.

### DETAILED DESCRIPTION

The detailed description explains the preferred embodiments, together with advantages and features, by way of example with reference to the drawings.

Scoring suppliers using subjective and objective criteria is one method for determining the suitability of a supplier. A flexible and efficient system and method for scoring suppliers is described below.

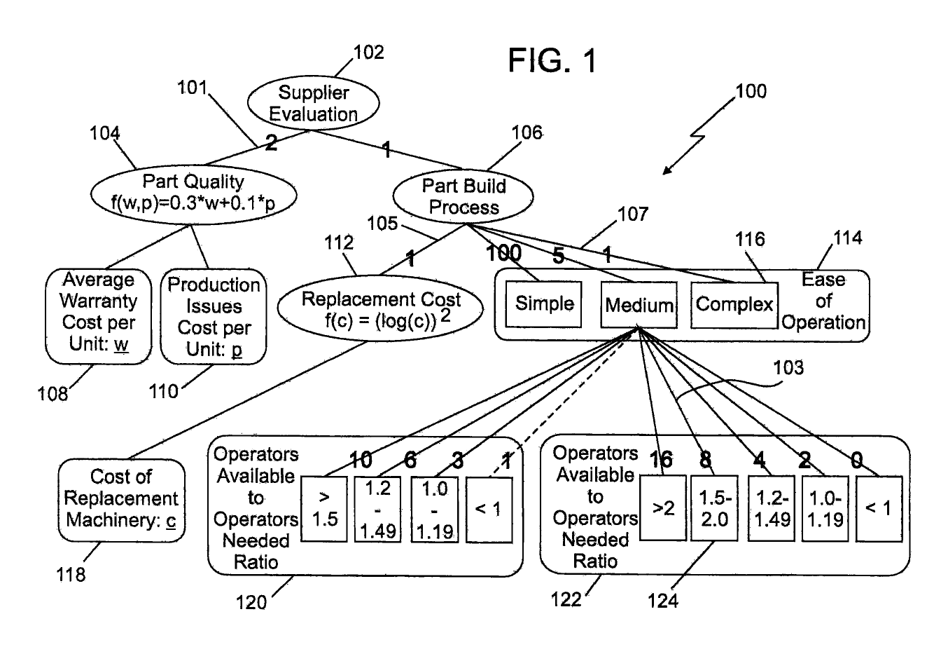

FIG. 1 illustrates an example of an embodiment of a scoring tree 100. The scoring tree 100 visually represents a hierarchical scoring system. The scoring tree includes a variety of nodes connected with links. In the hierarchical system, higher nodes are “parents” of “child” nodes, while child nodes of the same parent node are “sibling” nodes. For example, in FIG. 1, the node 102 is a parent node to nodes 104 and 106, while nodes 104 and 106 are siblings.

The scoring tree 100 includes a number of different types of nodes indicated by the shape of the node. For example, the node 102 is a function node indicated by an oval. The node 108 is an input node indicated by a rounded rectangle, and the node 124 is a discrete input node indicated by a proper rectangle. The discrete input nodes may include a discrete value or a range of discrete values. The nodes are connected with links, such as, for example a link 101. The links include numbers that may be used as a multiplier of a value (weights) from a connected node on the scoring tree 100. The numbers included on the links may also be used as a discrete value input to a connected node.

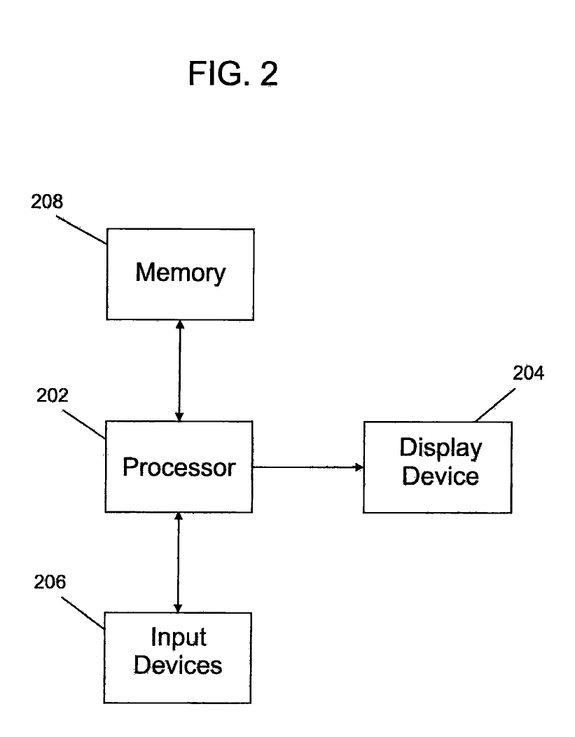

The scoring tree 100 may be designed and input by a user using a system that includes, for example, a graphical user interface. FIG. 2 illustrates an exemplary embodiment of a system that may be used to score supplier performance. The system 200 includes a processor 202 communicatively connected to a display 204, an input device 206, and a memory 208. In operation, a user may design and input a scoring tree into the system 200. The system 200 may then receive inputs used to score a supplier, and process the scoring tree using a method that will be described below.

The general operation of a scoring tree may be described by referencing the example scoring tree 100 of FIG. 1. The scoring tree 100 includes a node 102 labeled “supplier evaluation” representing the highest or “root node” on the scoring tree 100. The node 104 is a function node labeled “part quality” the node 104 includes a function that is used to output a value based on the inputs to the child nodes 108 and 110. For example, the node 108 receives an input “w” representing an average warranty cost per unit, and the node 110 receives an input “p” representing production issues cost per unit. The values from the nodes 108 and 110 are received by the node 104 and used in the function to result in a value. The value is sent to the node 102 after being multiplied by “2” as indicated in the link 101. In a similar manner, a node 112 receives an input from a node 118, performs a function, and sends an input to the node 106. Nodes 120 and 122 include discrete input nodes, for example, node 124. When a discrete input node is selected as an input, the discrete input node send a discrete value as indicated by a link. For example, if the operators available to operators needed ratio falls between 1.5 and 2.0, the discrete input node 124 is selected by a user. The value 8 is sent to a node 116 in the node 114. The node 116 is also a discrete input node, and sends a value of 1 to the node 106.

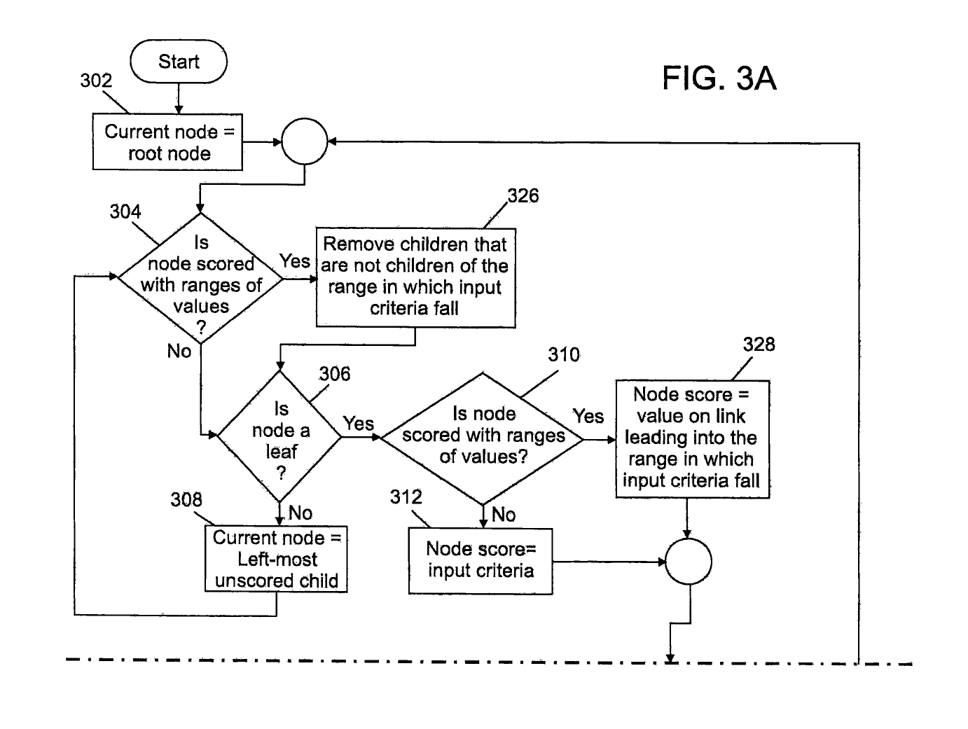

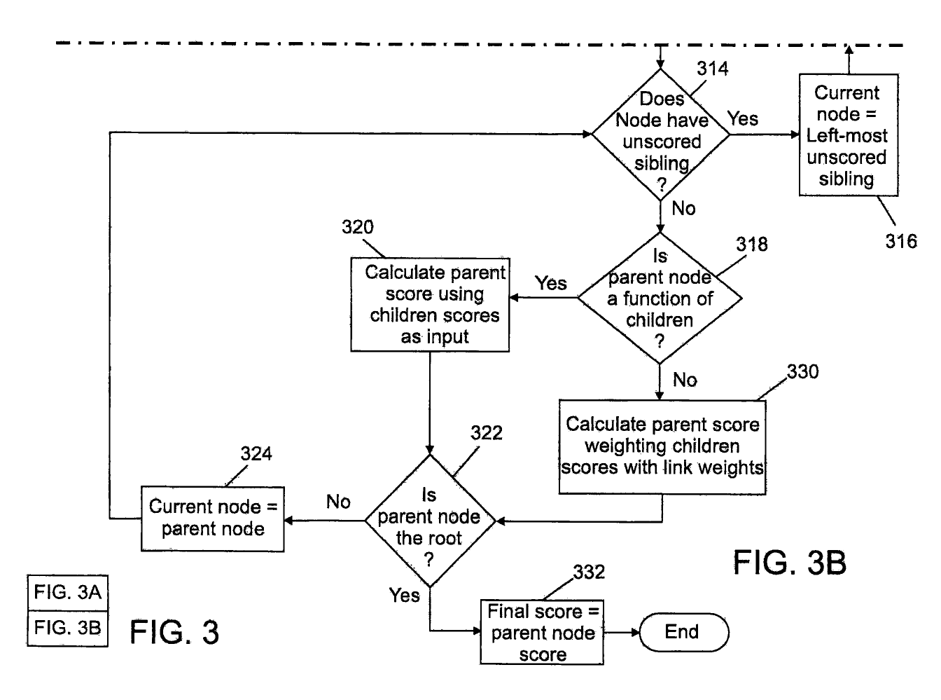

FIG. 3 illustrates a block diagram of an exemplary method for calculating a total score from a scoring tree. For exemplary purposes, FIG. 3 will be described in reference to the example scoring tree 100 (of FIG. 1). The method begins at the start block. In block 302 the current node is set as the root node (node 102 of FIG. 1). Block 304 determines whether the current node is scored with ranges of values, i.e., the current node includes possible ranges of inputs, for example, the node 114 includes ranges of inputs (“simple,” “medium,” and “complex”). Since the current node (102) is not scored with ranges of values, the method progresses to block 306. The current node (102) is not a leaf, so in block 308, the current node is changed to equal the left most unscored child, node 104. The current node 104 is not scored with a range of values in block 304 and is not a leaf in block 306, so the current node is changed to equal the left most unscored child, node 108. The current node (108) is not scored with ranges of values, but is a leaf as determined in block 306. A determination of whether the current node (108) is scored with ranges of values is repeated in block 310. In block 312, since the current node (108) is not scored with ranges of values, the node score is equal to the input criteria “w” of the current node (108). Block 314 determines whether the current node (108) includes an unscored sibling node. The current node (108) includes an unscored sibling (node 110). The current node is changed to left most unscored sibling (node 110) in block 316. The current node 110 is processed in a similar manner to the node 108 as described above.

In block 314, the method determines that the current node (110) does not include an unscored sibling. In block 318 the method determines that the parent node (104) is a function of the children (nodes 108 and 110). The parent node (104) score is calculated using the children (nodes 108 and 110) scores as inputs in block 320. In block 322 the method determines whether the parent node (104) is the root node. Since the parent node (104) is not the root node, the current node is changed to equal the parent node (104) in block 324.

In block 314, the method determines that the current node (104) has an unscored sibling node, node 106. The current node is changed to the left most unscored sibling node (106) in block 316. In block 304 the current node (106) is not scored with ranges of values. Since the current node (106) is not a leaf node, the nodes 112 and 118 are processed in a similar manner as the nodes 104 and 108 are processed above. Once node 112 is scored, the current node is changed to equal the node 114 (that is an unscored sibling of the node 112) in block 316.

Since the current node (114) is determined in block 304 to be scored with ranges of values, children are removed that are not children of the range in which input criteria fall. For example, if the operators available to operators needed ratio is 1.6, all of the children of the current node (114) that do not satisfy the range criteria are removed. Thus, the child node 120 is removed in block 326. Since the current node (114) is not a leaf node as determined in block 306, the current node is changed to equal the left most unscored child node (node 122). The current node (122) is scored with a range of values, but has no children to remove, so the method moves from block 304, through block 326 to block 306. The current node (122) is determined to be a leaf in block 306. Since the current node (122) is determined in block 310 to be scored with a range of values the node score equals the value on the link 103 leading into the range in which the criteria fall as shown in block 328. I.e., since the ratio is 1.6, falling in the range of node 124, the value “8” on the link 103 is used as the score of the current node (122). In block 314 the current node (122) is determined to not have an unscored sibling node (since the sibling node 120 was removed above for not being of the range of inputs). The parent node (114) is determined to be a function of the children in block 318, and the parent node (114) score is calculated using the children scores “8” from the current node (122) in block 320. The parent node (114) is not the root as determined in block 322. In block 324, the current node is changed to equal the parent node (114).

In block 314, the current node (114) does not have an unscored sibling, and the parent node (106) is not a function of the children nodes, as determined in block 318. In block 330, the parent node (106) is calculated weighing the children scores with link weights. I.e. the parent node (106) score equals the score of the node 112 multiplied by “1” (from the link 105) added to “8” (from the link 103) multiplied by 1 (from the link 107). In block 322, since the parent node (106) is not the root node, the current node changes to equal the parent node (106) in block 324.

In block 314 the method determines that the current node (106) does not have an unscored sibling node. (The node 104 has been scored as described above.) The parent node (102) is not a function of the children nodes (nodes 104 and 106), as determined in block 318. Block 330 calculates the parent node (102) score weighing the children node scores with link weights in a similar manner as described above.

Block 322 determines that the parent node (102) is the root node, and the score of the parent node (102) is equated to the final score in block 332. The method ends once block 332 is complete.

The technical effects and benefits of the above described embodiments provide a flexible, efficient, and effective method of scoring supplier performance.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The technical effects and benefits of the above described embodiments provide a flexible, efficient, and effective method of scoring supplier performance.

What is claimed is:

1. A method comprising:
receiving a supplier scoring tree having a first node including a first function of supplier performance connected via a first link to a second node operative to receive a first value associated with a metric of the supplier performance;
receiving the first value;
performing the first function of the first node;
outputting a result of the function to a display; and
displaying the result value to a user for analysis of supplier performance by the user.

2. The method of claim 1, wherein the first link is associated with a first scaling value.

3. The method of claim 2, further comprising multiplying a resultant value of the first function by the first scaling value to define the result of the function.

4. The method of claim 1, wherein the supplier scoring tree further includes a third node including a second function of supplier performance connected via a second link to the first node.

5. A system comprising:
a processor operative to receive a function of a supplier performance, define a first node to include the function of the supplier performance, receive a first value associated with a metric of the supplier performance, define a second node to receive the first value associated with a metric of the supplier performance, and connect the first node to the second node with a link, output the defined supplier scoring tree; and
a display operative to receive and display the defined supplier scoring tree to a user for analysis of supplier performance by the user.

6. The system of claim 5, wherein the processor is further operative to associate a scaling value with the link.

7. The system of claim 5, wherein the first node is a linear function.

8. The system of claim 5, wherein the first node is a non-linear function.

9. The system of claim 5, wherein the second node includes a plurality of discrete value inputs.

10. The system of claim 5, wherein the second node includes an input with discrete value range.
